(19) United States
(12) Patent Application Publication
(10) Pub. No.: US 2025/0317392 A1
(43) Pub. Date: Oct. 9, 2025

(54) SELECTIVE CHOICE OF NAT METHODS BASED ON APPLICATION TYPE USING SD-WAN CENTRALIZED POLICIES

(71) Applicant: Cisco Technology, Inc., San Jose, CA (US)

(72) Inventors: Hari Krishna Donti, Dublin, CA (US); Deepthi Tammireddy, Dublin, CA (US); Sampath Sthothra Bhasham, Santa Clara, CA (US); Sanjay Sreenath, San Jose, CA (US)

(21) Appl. No.: 18/778,688

(22) Filed: Jul. 19, 2024

Related U.S. Application Data
(60) Provisional application No. 63/631,118, filed on Apr. 8, 2024.

(51) Int. Cl. H04L 45/76; H04L 45/74; H04L 61/2557

(52) U.S. Cl. CPC H04L 45/76; H04L 45/74; H04L 61/2557

(57) ABSTRACT

In one aspect, a method for managing traffic in an SD-WAN controller is disclosed. The method involves receiving a policy from an SD-WAN controller at an edge network device in an SD-WAN. This policy specifies a NAT method for DIA action and includes configurations for selecting the NAT method. The method includes receiving data traffic at the edge network device, where the traffic is matched with the configurations in the policy to identify a supporting NAT method. The NAT method is selected based on the data traffic matching a configuration in the policy. An available DIA path corresponding to the configuration is chosen, and an IP address consistent with the NAT method specified by the policy is applied to the data traffic. The data traffic is routed along the available DIA path based on the configurations and the IP address applied during the NAT method in accordance with the policy.

### CROSS-REFERENCE TO RELATED APPLICATIONS

This application claims priority to U.S. provisional application No. 63/631,118, filed on Apr. 8, 2024, which is expressly incorporated by reference herein in its entirety.

### FIELD OF THE TECHNOLOGY

The present technology relates to network communication and routing technologies, specifically Software-Defined Wide Area Networking (SD-WAN) technologies. More particularly, the proposed technology encompasses methods for associating specific application traffic originating from SD-WAN routers to specific source IP addresses to enhance security, improve network performance, and facilitate traffic management.

### BACKGROUND

SD-WAN represents a transformative approach to networking that leverages software-defined networking (SDN) principles to enhance the management and operation of wide-area networks. At its core, SD-WAN decouples networking hardware from its control mechanism, enabling centralized control and orchestration of network traffic flows across geographically dispersed locations. This paradigm shift allows organizations to connect their branch offices, data centers, and cloud resources efficiently while optimizing performance, reliability, and security. In essence, SD-WAN technology dynamically directs network traffic across various pathways, including MPLS, broadband Internet, and cellular connections, based on real-time conditions and application requirements. Through centralized management and policy-based routing, SD-WAN controllers intelligently route traffic to ensure optimal performance and reliability.

In SD-WAN, a centralized data policy facilitates the classification and redirection of traffic, particularly for network address translation (NAT) and Direct Internet Access (DIA). This centralized approach enables efficient network traffic management by categorizing it based on predefined policies. Once traffic matches a specified policy, it undergoes redirection for DIA, where the traffic exits the network locally after undergoing source IP translation. The translation process, facilitated by the NAT module, employs various methods such as utilizing IP addresses from the WAN interface, NAT pool, or loopback interface. This approach ensures streamlined traffic flow and effective utilization of network resources within the SD-WAN infrastructure, enhancing overall network performance and security.

### BRIEF DESCRIPTION OF THE SEVERAL VIEWS OF THE DRAWINGS

In order to describe the manner in which the features of the disclosure can be obtained, a more description of the principles of the present technology will be rendered by reference to aspects thereof which are illustrated in the appended drawings. Understanding that these drawings depict exemplary aspects of the disclosure and are not therefore to be considered to be limiting of its scope, the principles herein are described and explained with additional specificity and detail through the use of the accompanying drawings in which:

FIG. 1 illustrates an example of a high-level network architecture in accordance with some aspects of the present technology.

FIG. 2 illustrates an example process for applying a policy based on a selected NAT method according to some aspects of the present technology.

FIG. 3 illustrates an example network architecture for a policy selecting a NAT method for handling data traffic based on the direct Internet access (DIA) available according to some aspects of the present technology.

FIG. 4 illustrates a process for managing traffic in a Software-Defined Wide Area Network (SD-WAN) controller according to some aspects of the present technology.

FIG. 5 illustrates an example for managing traffic along an available WAN link in a software-defined wide area network (SD-WAN) controller.

FIG. 6 illustrates an example of a computing system according to some aspects of the present technology.

### DETAILED DESCRIPTION

Various examples of the disclosure are discussed in detail below. While specific implementations are discussed, it should be understood that this is done for illustration purposes. A person skilled in the relevant art will recognize that other components and configurations can be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an example in the present disclosure can be references to the same example or any example; and, such references mean at least one of the examples.

The terms used in this specification generally have their ordinary meanings in the art, within the context of the disclosure, and in the specific context where each term is used. Alternative language and synonyms can be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative, and is not intended to further limit the scope and meaning of the disclosure or of any example term. Likewise, the disclosure is not limited to various embodiments given in this specification.

Additional features and advantages of the disclosure will be set forth in the description that follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### Overview

The proposed solution enables service providers to pin specific application traffic from SD-WAN routers to designated source IP addresses. This allows for improved security, optimized network performance, and more efficient traffic management, while also aiding in compliance with regulatory requirements. The proposed solution offers the flexibility to select a NAT method for DIA action for specific application types, rather than applying a default NAT method universally. A multi-WAN link setup allows the provisioning of multiple NAT methods within the SDWAN Centralized Data Policy, enabling the selection of a NAT method based on the DIA Path preference and availability.

In one aspect, the techniques described herein relate to a method for managing traffic in an SD-WAN controller, including: receiving a policy at an edge network device in an SD-WAN from an SD-WAN controller, the policy specifying a NAT method for DIA action, and includes one or more configurations for selection of the NAT method; receiving, at the edge network device, data traffic, wherein the data traffic is matched with the one or more configurations in the policy to identify a NAT method that supports the data traffic received; selecting the NAT method based on the data traffic matching a respective configuration of the one or more configurations in the policy; selecting an available DIA path that corresponds to the respective configuration; selecting an IP address that is consistent with the NAT method specified by the policy to apply to the data traffic; and routing the data traffic along the available DIA path based on the one or more configurations and the IP address applied during the NAT method in accordance with the policy.

In some aspects, the techniques described herein relate to a method, wherein the selection of the NAT method includes: receiving, at the edge network device, the data traffic associated with an application, wherein the data traffic is matched with an application type supported by the policy associated with the NAT method; selecting the NAT method based on the application type matching the respective configuration of the one or more configurations in the policy; and selecting the IP address that is consistent with the NAT method associated with the application type as specified by the policy.

In some aspects, the techniques described herein relate to a method, wherein the NAT method is selected based on an indication in the policy and the available DIA path for an application type associated with an application.

In some aspects, the techniques described herein relate to a method, wherein: the policy is configured by an administrator of the SD-WAN at a central management platform, the policy specifying the NAT method for the DIA action; and the policy is pushed from the central management platform to the SD-WAN controller to disseminate the policy to one or more edge network devices in the SD-WAN.

In some aspects, the techniques described herein relate to a method, wherein each NAT method is associated with one or more WAN interfaces of an SD-WAN network topology.

In some aspects, the techniques described herein relate to a method, wherein the policy includes criteria for matching one or more applications and includes multiple NAT methods for an application type based on a DIA path preference and an availability of the DIA path preference.

In some aspects, the techniques described herein relate to a method, further including determining from the data traffic received from one or more edge network devices in the SD-WAN that the data traffic originated from an edge network device associated with specific source IP addresses; and assigning one or more IP addresses to the data traffic based on the edge network device the data traffic originated from.

In some aspects, the techniques described herein relate to a method, further including receiving one or more instructions from network resources in the SD-WAN, wherein the one or more instructions are utilized to apply one or more NAT methods in the policy to data traffic received from an application.

In some aspects, the techniques described herein relate to a method wherein the policy specifies multiple NAT methods for one or more corresponding DIA paths, the multiple NAT methods specifying a NAT pool or a WAN IP address to assign to the data traffic.

In one aspect, the techniques described herein relate to a network device including: one or more memories having computer-readable instructions stored therein; and one or more processors configured to execute the computer-readable instructions to: receiving a policy at an edge network device in an SD-WAN from an SD-WAN controller, the policy specifying a NAT method for DIA action, and includes one or more configurations for selection of the NAT method; receiving, at the edge network device, data traffic, wherein the data traffic is matched with the one or more configurations in the policy to identify a NAT method that supports the data traffic received; selecting the NAT method based on the data traffic matching a respective configuration of the one or more configurations in the policy; selecting an available DIA path that corresponds to the respective configuration; selecting an IP address that is consistent with the NAT method specified by the policy to apply to the data traffic; and routing the data traffic along the available DIA path based on the one or more configurations and the IP address applied during the NAT method in accordance with the policy.

In one aspect, the techniques described herein relate to a non-transitory computer-readable storage medium including computer-readable instructions, which when executed by one or more processors of a network appliance, cause the network appliance to: receiving a policy at an edge network device in an SD-WAN from an SD-WAN controller, the policy specifying a NAT method for DIA action, and includes one or more configurations for selection of the NAT method; receiving, at the edge network device, data traffic, wherein the data traffic is matched with the one or more configurations in the policy to identify a NAT method that supports the data traffic received; selecting the NAT method based on the data traffic matching a respective configuration of the one or more configurations in the policy; selecting an available DIA path that corresponds to the respective configuration; selecting an IP address that is consistent with the NAT method specified by the policy to apply to the data traffic; and routing the data traffic along the available DIA path based on the one or more configurations and the IP address applied during the NAT method in accordance with the policy.

In one aspect, a method for managing traffic in a software-defined wide area network (SD-WAN) controller, includes receiving a policy at an edge network device in an SD-WAN from an SD-WAN controller, the policy specifying a network address translation method (NAT method) for direct Internet access (DIA) action, and includes one or more configurations for selection of the NAT method per WAN link managed by one or more Internet Service Providers), receiving, at the edge network device, data traffic, where the data traffic is matched with the one or more configurations in the policy to identify the NAT method that supports the data traffic received, selecting the NAT method based on the data traffic matching a respective configuration of the one or more configurations in the policy, where the NAT method is selected from a plurality of NAT methods in the policy corresponding to one or more WAN links associated with a WAN IP address or a NAT pool, selecting an available DIA path that corresponds to the respective configuration and a specific WAN link managed by the one or more ISPs, selecting the WAN IP address that is consistent with the NAT method specified by the policy that is associated with the one or more ISPs to apply to the data traffic, and routing the data traffic along the available WAN link based on the one or more configurations and the WAN IP address applied during the NAT method in accordance with the policy.

### Example Embodiments

Additional features and advantages of the disclosure will be set forth in the description that follows and, in part, will be obvious from the description or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

In the current implementation of SD-WAN, there are challenges in the flexibility of NAT method selection based on application type and WAN link management. Current solutions allow for a single NAT selection, often configured as a default. Allowing a single NAT selection poses a problem that primarily revolves around the inability to customize NAT methods for different types of traffic, resulting in suboptimal performance and management challenges.

In SD-WAN environments, centralized data policies are employed to classify and redirect traffic for NAT for DIA action, translating source IP addresses via the NAT module. The NAT module can utilize IP addresses from the WAN interface, a NAT pool, or a loopback interface. However, a significant challenge exists, where all DIA traffic is restricted to a single NAT method for source IP translation. This inflexibility prevents the selection of a NAT method based on the application type, leading to several issues.

For example, in cloud environments using Voice over Internet Protocol (VOIP) or real-time communication applications, specific source IP addresses are often utilized for enhanced security, improved network performance, and compliance. For instance, VOIP applications often utilize consistent and low-latency connections, which can be better managed with dedicated IP addresses. Similarly, application traffic from Office365 (O365) teams would ideally use an IP address from a NAT pool rather than the WAN interface's public IP. This approach would provide better load distribution and enhanced security. However, current SDWAN implementations cannot meet these requirements due to the lack of flexibility in NAT method selection.

This restriction leads to inefficiencies and increased vulnerability in network traffic management. Organizations cannot optimize network performance or ensure the proper security measures for sensitive applications without the ability to select different NAT methods based on application type. The inability to tailor NAT methods to specific applications results in a one-size-fits-all approach, which is suboptimal for modern, dynamic network environments that utilize granular control and customization to meet diverse application needs.

To address the challenge of a lack of NAT method selection per application type in SD-WAN environments, the proposed technology provides methods for implementing a more flexible SD-WAN Data Policy to classify application traffic and specify NAT methods based on application match criteria. This approach allows users to designate specific NAT methods for DIA based on the type of application traffic received.

By leveraging this enhanced policy, the system can utilize the source IP address from the specified NAT method for traffic traversing the DIA link. This user configuration flexibility allows administrators to specify different NAT methods for available links, ensuring that the appropriate NAT method is applied to each application type. This not only optimizes network performance but also enhances security and compliance.

Additionally, the policy defines a color preference, which refers to the SD-WAN route type, and automatically associates the NAT pool with the relevant interface. This seamless integration ensures that the correct NAT method is employed for the specified application traffic, thereby addressing the inefficiencies and vulnerabilities previously experienced. This solution enhances network traffic management's overall efficiency and security in SD-WAN environments by matching the correct NAT method to the specified application traffic.

In another challenge, the current implementation of SD-WAN poses a significant issue in cases where multiple WAN links are managed by different Internet Service Providers (ISPs). Each ISP provides specific public addresses as NAT pools to the SD-WAN router. While SD-WAN data policies allow for selecting a preferred WAN link with active-active or active-backup preferences, they fall short of enabling the selection of NAT pools for each WAN link within the policy. Instead, only a default NAT method is available, severely limiting the ability to optimize traffic based on the specific characteristics of each ISP. The inability to apply tailored NAT methods that leverage the unique benefits of each ISP's infrastructure prevents organizations from optimizing network performance, reliability, and cost-effectiveness. In diverse and complex networking environments, this constraint can lead to suboptimal use of resources and increased operational inefficiencies. Consequently, organizations struggle to maximize their network's potential, compromising on performance and strategic objectives due to the lack of flexibility in NAT method selection per WAN link.

The proposed technology offers a solution to the challenge of the lack of NAT method selection per WAN link managed by different ISPs in SD-WAN environments. An administrator can specify multiple NAT methods corresponding to specific DIA WAN links managed by different ISPs. This enhanced capability allows policies to classify application types and select the appropriate NAT method based on user-defined configurations, such as preferred color or WAN link.

By translating the source IP using the configured NAT method, the solution ensures efficient and secure traffic routing tailored to the characteristics of each ISP's infrastructure. Implementing this solution requires updates to the SD-WAN controller and edge devices within the SD-WAN infrastructure. The SD-WAN controller interprets user intent from the centralized data policy and pushes the relevant configuration to the edge devices.

Once the edge devices receive this configuration, they classify traffic according to the user-defined criteria and apply the appropriate NAT method. This approach optimizes traffic management, leveraging the specific benefits of each ISP's infrastructure to achieve high performance and enhanced security.

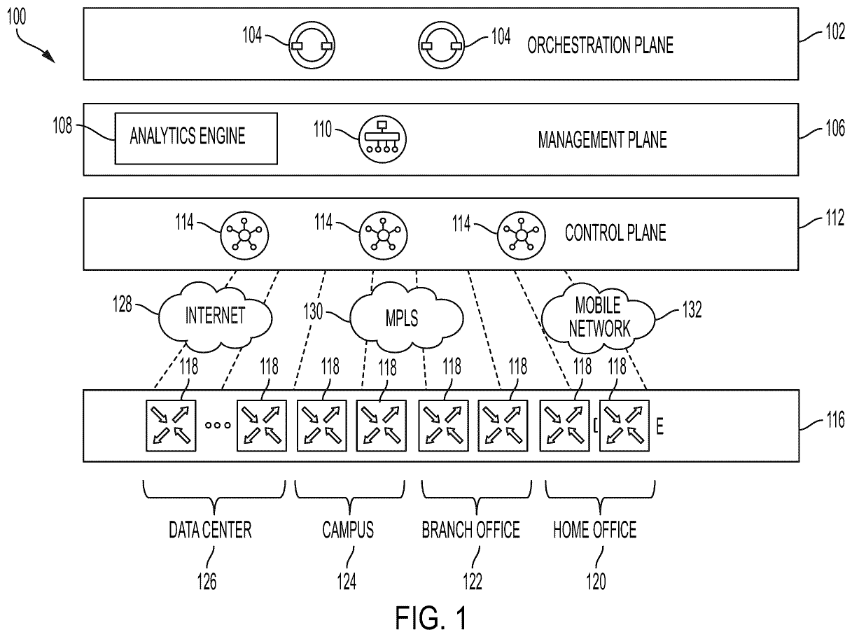

FIG. 1 illustrates an example of a network architecture 100 for implementing aspects of the present technology. An example of an implementation of the network architecture 100 is the Cisco® SD-WAN architecture. However, one of ordinary skill in the art will understand that, for the network architecture 100 and any other system discussed in the present disclosure, there can be additional or fewer component in similar or alternative configurations. The illustrations and examples provided in the present disclosure are for conciseness and clarity. Other embodiments may include different numbers and/or types of elements but one of ordinary skill the art will appreciate that such variations do not depart from the scope of the present disclosure.

In this example, the network architecture 100 can comprise an orchestration plane 102, a management plane 106, a control plane 112, and a data plane 116. The orchestration plane 102 can assist in the automatic on-boarding of edge network device 118 (e.g., switches, routers, etc.) in an overlay network. The orchestration plane 102 can include network orchestrator appliances 104, which can be physical or virtual. The network orchestrator appliances 104 can perform the initial authentication of the edge network devices 118 and orchestrate connectivity between devices of the control plane 112 and the data plane 116. In some embodiments, the network orchestrator appliances 104 can also enable communication of devices located behind Network Address Translation (NAT). In some embodiments, physical or virtual Cisco® SD-WAN vBond appliances can operate as the network orchestrator appliances 104.

The management plane 106 can be responsible for central configuration and monitoring of a network. Management plane 106 can include one or more of network management appliance 110, which can be physical or virtual and an analytics engine 108. In some embodiments, the network management appliances 110 can provide centralized management of the network via a graphical user interface to enable a user to monitor, configure, and maintain the edge network devices 118 and links (e.g., Internet transport network 128, MPLS network 130, 4G/mobile network) in an underlay and overlay network. The network management appliances 110 can support multi-tenancy and enable centralized management of logically isolated networks associated with different entities (e.g., enterprises, divisions within enterprises, groups within divisions, etc.). Alternatively, or in addition, the network management appliance 110 can be a dedicated network management system for a single entity. In some embodiments, physical or virtual Cisco® SD-WAN Manage appliances can operate as the network management appliances 110.

The control plane 112 can build and maintain a network topology and make decisions on where traffic flows. The control plane 112 can include one or more network control appliances 114 that are physical or virtual. The network control appliances 114 can establish secure connections to each edge network device 118 and distribute route and policy information via a control plane protocol (e.g., Overlay Management Protocol (OMP) (discussed in further detail below), Open Shortest Path First (OSPF), Intermediate System to Intermediate System (IS-IS), Border Gateway Protocol (BGP), Protocol-Independent Multicast (PIM), Internet Group Management Protocol (IGMP), Internet Control Message Protocol (ICMP), Address Resolution Protocol (ARP), Bidirectional Forwarding Detection (BFD), Link Aggregation Control Protocol (LACP), etc.). In some embodiments, the network control appliances 114 can operate as route reflectors. The network control appliances 114 can also orchestrate secure connectivity in the data plane 116 between and among the edge network devices 118. For example, in some embodiments, the network control appliances 114 can distribute crypto key information among the edge network devices 118. This can allow the network to support a secure network protocol or application (e.g., Internet Protocol Security (IPSec), Transport Layer Security (TLS), Secure Shell (SSH), etc.) without Internet Key Exchange (IKE) and enable scalability of the network. In some embodiments, physical or virtual Cisco® SD-WAN vSmart controllers can operate as the network control appliances 114.

The data plane 116 can be responsible for forwarding packets based on decisions from the control plane 112. The data plane 116 can include the edge network devices 118, which can be physical or virtual edge network devices. The edge network devices 118 can operate at the edges various network environments of an organization, such as in one or more data centers 126, campus networks 124, branch office networks 122, home office networks 120, and so forth, or in the cloud (e.g., Infrastructure as a Service (IaaS), Platform as a Service (PaaS), SaaS, and other cloud service provider networks). The edge network devices 118 can provide secure data plane connectivity among sites over one or more WAN transports, such as via Internet transport networks 128 (e.g., Digital Subscriber Line (DSL), cable, etc.), MPLS networks 130 (or other private packet-switched network (e.g., Metro Ethernet, Frame Relay, Asynchronous Transfer Mode (ATM), etc.), mobile networks 132 (e.g., 3G, 4G/LTE, 5G, etc.), or other WAN technology (e.g., Synchronous Optical Networking (SONET), Synchronous Digital Hierarchy (SDH), Dense Wavelength Division Multiplexing (DWDM), or other fiber-optic technology; leased lines (e.g., T1/E1, T3/E3, etc.); Public Switched Telephone Network (PSTN), Integrated Services Digital Network (ISDN), or other private circuit-switched network; small aperture terminal (VSAT) or other satellite network; etc.). The edge network devices 118 can be responsible for traffic forwarding, security, encryption, quality of service (QOS), and routing (e.g., BGP, OSPF, etc.), among other tasks. In some embodiments, physical or virtual Cisco® SD-WAN vEdge routers can operate as the edge network devices 118.

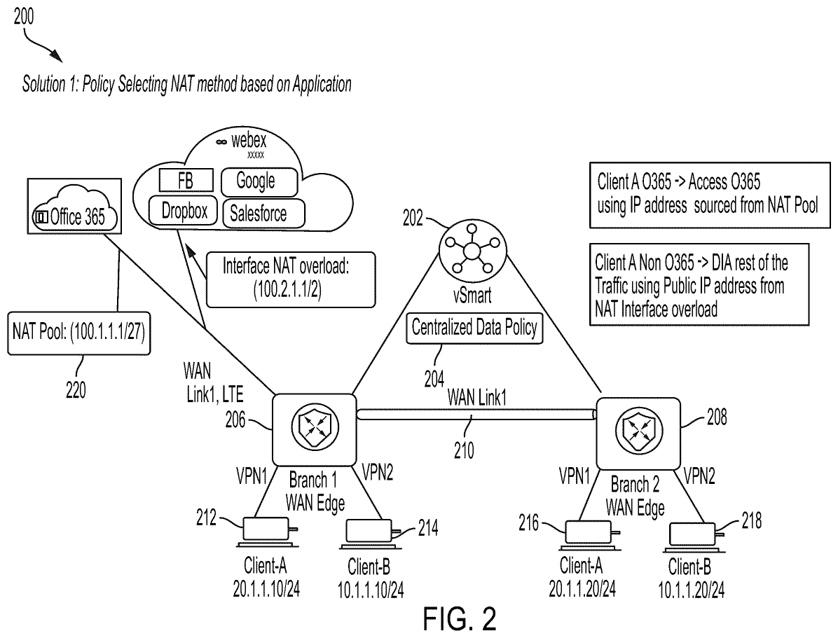

FIG. 2 illustrates an example process 200 for applying a policy based on a selected NAT method according to some aspects of the present technology.

The proposed technology introduces methods for implementing a flexible SD-WAN data policy capable of classifying application traffic and specifying NAT methods based on application match criteria. Accordingly, a user can designate specific NAT methods for DIA according to the type of application traffic.

By leveraging an SD-WAN data policy 204, an SD-WAN controller 202 can apply the source IP address from a NAT method specified in the SD-WAN data policy 204 to application traffic traversing the WAN link 210 for direct internet access. By utilizing the SD-WAN data policy 204 for application traffic, different NAT methods can be specified for multiple WAN links 210 available in the SD-WAN, as supported by the SD-WAN controller 202. For a specific application match criterion, an administrator can specify the NAT method for DIA action, allowing the policy to use the source IP address from the specified method while performing NAT for traffic passing through the WAN link 210.

In an example, as shown in FIG. 2, involving Office365 (O365) traffic, the SD-WAN controller 202 can receive an SD-WAN data policy 204 from a central management platform. The SD-WAN data policy 204 can be pushed from the SD-WAN controller 202 to SD-WAN edge network device 206 and SD-WAN edge network device 208. The SD-WAN data policy 204 specifies a NAT method for the SD-WAN edge network devices 206 and 208 to implement for a DIA action, including configurations for selecting a specific NAT method to apply to application traffic association with one or more applications in the SD-WAN.

For example, SD-WAN edge network devices 206 and 208 can receive data traffic associated with an application transmitted between the O365 application and client devices 212, 214, 216, and 218. SD-WAN edge network devices 206 and 208 then perform a matching procedure to identify an application type within an application list specified in the SD-WAN data policy 204 that is applicable to the received data traffic. In order to identify the application type, SD-WAN edge network device 206 can inspect the data traffic to identify the application type of the data traffic based on predefined criteria specified by the SD-WAN data policy 204 which includes either a predefined or user-defined collection of application types that utilize specific handling. These application types can be individual applications or groups of applications.

Once a matching application type is found by comparing the data traffic to the application list, an appropriate NAT method is applied as specified by the SD-WAN data policy 204 for the matched application type. As shown in FIG. 2, a source IP address is selected from a NAT pool 220, comprising a plurality of source IP addresses to apply to the data traffic associated with the application type in accordance with the selected NAT method.

The matched traffic is then processed using the selected NAT method, ensuring that the application traffic identified as O365 traffic exclusively uses IP addresses from NAT pool 220.

A default source IP address can be utilized for additional data traffic that does not pertain to O365. Alternatively, another source IP designated by the policy can be applied, ensuring that all traffic is handled appropriately according to its classification and the associated SD-WAN data policy 204 directives.

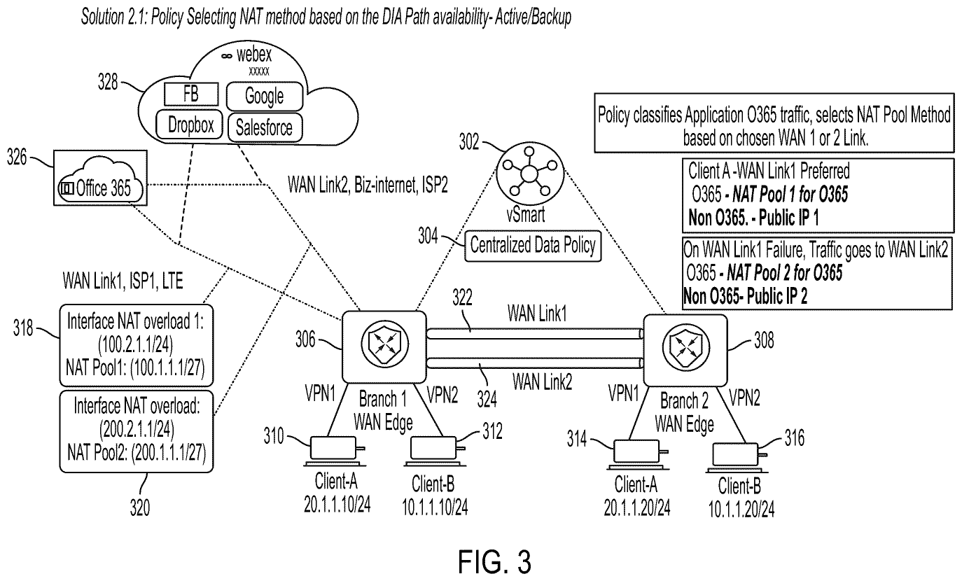

FIG. 3 illustrates an example network architecture for a policy selecting a NAT method for handling data traffic based on the direct Internet access (DIA) available according to some aspects of the present technology.

In FIG. 3, a NAT method selection can be performed for each WAN link managed by different Internet Service Providers (ISPs) within the SD-WAN environment. An administrator can specify multiple NAT methods corresponding to the specific WAN links managed by different ISPs in the SD-WAN data policy.

In FIG. 3, a NAT method selection can be performed for each WAN link, WAN link 1 322 and WAN link 2 324, managed by different ISPs within the SD-WAN environment. WAN link 1 322 and 324 provides a dedicated, private Internet connection between client devices 310, 312, 314, or 316, and the Internet. WAN link 1 322 and WAN link 2 324 provides the ability to ensure that the subscribed bandwidth is exclusively available to the subscriber, offering consistent performance, reliability, and guaranteed upload and download speeds. Within this context, an administrator can specify multiple NAT methods corresponding to WAN link 1 322 and WAN link 2 324, managed by different ISPs.

In an example, the SD-WAN controller 302 can push an SD-WAN data policy 304 to edge network device 306 and edge network device 308. This policy specifies NAT methods associated with WAN link 1 322 and WAN link 2 324. By doing so, the SD-WAN controller ensures that each edge network device is configured with the appropriate NAT methods tailored to the specific WAN links they manage.

WAN link 1 322 and WAN link 2 324 may be managed by different ISPs, each providing distinct public addresses in NAT pool 1 318 and NAT pool 2 320. The SD-WAN data policy 304 can specify how data traffic is to be handled based on the WAN link traversed. For instance, the SD-WAN data policy 304 can specify that traffic routed through WAN link 1 322 is to use a NAT method that utilizes NAT pool 1 318 provided by the ISP managing that link. Similarly, traffic through WAN link 2 324 would use a different NAT method aligned with its corresponding ISP's infrastructure, further specifying the use of NAT pool 2 320.

As shown in FIG. 3, the SD-WAN controller 302 can classify O365 326 data traffic by selecting NAT pool 1 318 after determining that the data traffic is being routed through WAN Link 1 322, which is associated with a first ISP, as specified by the SD-WAN data policy. Similarly, the SD-WAN controller 302 can classify WebEx 328 data traffic by selecting NAT pool 2 320, which is associated with a second ISP, after determining that the data traffic is being routed through WAN Link 2 324, as specified by the SD-WAN data policy. Once the data traffic is classified as associated with a particular application, edge network devices 306 and 308 select the appropriate NAT method and route the traffic according to the NAT method specified by the SD-WAN data policy.

The SD-WAN data policy 304 can further include configurations that specify enterprise preferences as they pertain to each of the ISPs associated with WAN link 1 322 and WAN link 2 324. For example, the SD-WAN data policy 304 can specify a preferred WAN link for data traffic associated with a particular application and a NAT pool to assign to the application data traffic. Upon receiving data traffic associated with O365 326, the SD-WAN data policy 304 can specify that WAN link 1 322 is preferred, NAT pool 1 318 should be utilized for O365 326 data traffic, and any non-O365 data traffic received should use a specified public IP address.

In another example, where there is a WAN link failure, the SD-WAN data policy 304 can specify a preferred WAN link. For instance, the policy can specify that upon detection of a WAN link 1 322 failure, data traffic identified as being associated with O365 326 is to be rerouted to WAN link 2 324, assigned NAT pool 2 320 to perform the NAT method, and any non-O365 326 traffic should be assigned a specified public IP address. These configurations ensure seamless and efficient traffic management, maintaining optimal network performance and reliability during link failures. In some instances, each of these examples can be specified in the SD-WAN data policy 304 separately, conditionally, or in combination.

In some examples, the SD-WAN data policy 304 can direct edge network devices 306 and 308 to select a NAT method for handling data traffic based on DIA path selection. The SD-WAN data policy 304 can classify application types and select the corresponding NAT method based on administrator configurations specified by the SD-WAN data policy 304. The source IP address can then be translated using the configured NAT method, ensuring that application traffic is handled according to the specified policy. The SD-WAN data policy 304 can also load balance intended application data traffic across available DIA paths.

In an example, client device 310 can select NAT Pool 1 318 for O365 326 data traffic received on WAN link 1 322 and a first public IP address for non-O365 data traffic, per SD-WAN data policy 304. To perform load balancing, client device 310 can further select NAT Pool 2 320 for O365 326 data traffic received on WAN link 2 324 and a second public IP address for non-O365 data traffic, per SD-WAN data policy 304.

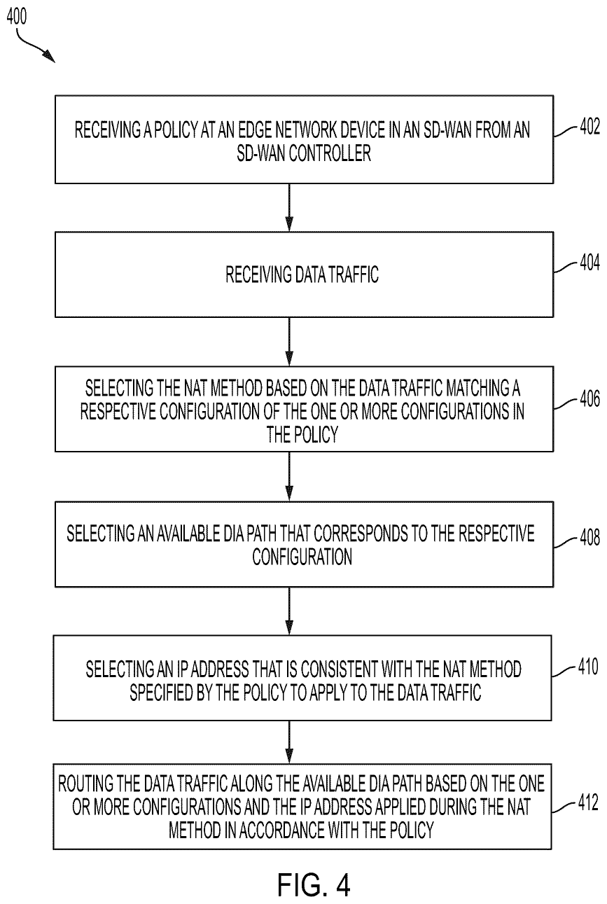

FIG. 4 illustrates a process 400 for managing traffic in a Software-Defined Wide Area Network (SD-WAN) controller, in accordance with one embodiment. Although the example process 400 depicts a particular sequence of operations, the sequence may be altered without departing from the scope of the present disclosure. For example, some of the operations depicted may be performed in parallel or in a different sequence that does not materially affect the function of the process 400. In other examples, different components of an example device or system that implements the process 400 may perform functions at substantially the same time or in a specific sequence.

According to some examples, the method includes receiving a policy at an edge network device in an SD-WAN from an SD-WAN controller at block 402. For example, the edge network device 306 illustrated in FIG. 3 may receive a policy at an edge network device in an SD-WAN from an SD-WAN controller. The policy is configured by an SD-WAN administrator at a central management platform, specifying the NAT method for the DIA action. This policy is pushed from the central management platform to the SD-WAN controller, which then disseminates it to one or more edge network devices within the SD-WAN. The policy includes configurations for selecting the NAT method and criteria for matching one or more applications. The policy comprises multiple NAT methods for an application type based on a DIA path preference and the availability of the DIA path. The policy explicitly specifies a network address translation (NAT) method for direct Internet access (DIA) action.

According to some examples, the method includes receiving data traffic at block 404. For example, the edge network device 306 illustrated in FIG. 3 may receive data traffic. The data traffic is matched with the configurations in the policy to identify a NAT method that supports the received data traffic. The NAT method is selected based on an indication in the policy and the available DIA path for an application type associated with an application. The NAT method is linked to one or more WAN interfaces of the SD-WAN network topology. By analyzing the data traffic received from edge network devices in the SD-WAN, it is determined that the traffic originated from edge network devices associated with specific source IP addresses. Additionally, one or more IP addresses are assigned to the data traffic based on the originating edge network device.

According to some examples, the method includes selecting the NAT method based on the data traffic matching a respective configuration of the one or more configurations in the policy at block 406. For example, the edge network device 306 illustrated in FIG. 3 may select the NAT method based on the data traffic matching a respective configuration of one or more configurations in the policy. The selection of the NAT method includes receiving data traffic associated with an application at the edge network device. The data traffic is matched with an application type supported by the policy associated with the NAT method. The selection process involves choosing the NAT method based on the application type matching the respective configuration in the policy. Additionally, the selection of the NAT method includes selecting the IP address consistent with the NAT method associated with the application type as specified by the policy.

According to some examples, the method includes selecting an available DIA path that corresponds to the respective configuration at block 408. For example, the edge network device 306 illustrated in FIG. 3 may select an available DIA path that corresponds to the respective configuration.

According to some examples, the method includes selecting an IP address that is consistent with the NAT method specified by the policy to apply to the data traffic at block 410. For example, the edge network device 306 illustrated in FIG. 3 may select an IP address that is consistent with the NAT method specified by the policy to apply to the data traffic.

According to some examples, the method includes routing the data traffic along the available WAN link based on the one or more configurations and the IP address applied during the NAT method in accordance with the policy at block 412. For example, the edge network device 306 illustrated in FIG. 3 may route the data traffic along the available DIA path based on one or more configurations and the IP address applied during the NAT method in accordance with the policy.

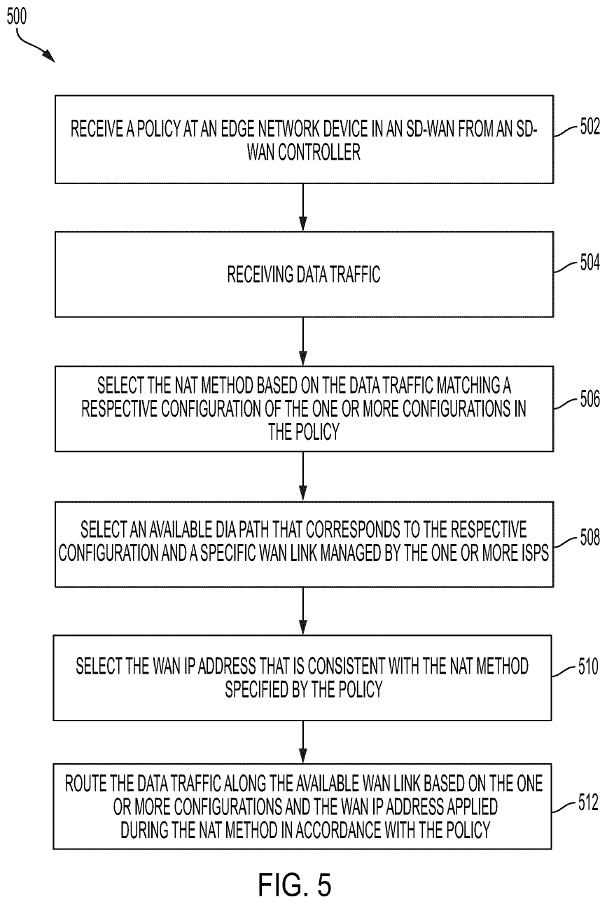

FIG. 5 illustrates an example process 500 for managing traffic along an available WAN link in a software-defined wide area network (SD-WAN) controller. Although the example process 500 depicts a particular sequence of operations, the sequence may be altered without departing from the scope of the present disclosure. For example, some of the operations depicted may be performed in parallel or in a different sequence that does not materially affect the function of the process 500. In other examples, different components of an example device or system that implements the process 500 may perform functions at substantially the same time or in a specific sequence.

According to some examples, the method includes receiving a policy at an edge network device in an SD-WAN from an SD-WAN controller at block 502. For example, the edge network device 306 illustrated in FIG. 3 may receive a policy at an edge network device in an SD-WAN from an SD-WAN controller. The policy specifies a network address translation (NAT) method for DIA action and includes one or more configurations for the selection of the NAT method per WAN link managed by one or more ISPs.

According to some examples, the method includes receiving data traffic at block 504. For example, the edge network device 306 illustrated in FIG. 3 may receive data traffic. The data traffic is matched with the one or more configurations in the SD-WAN data policy 304 to identify the NAT method that supports the data traffic received.

According to some examples, the method includes selecting the NAT method based on the data traffic matching a respective configuration of the one or more configurations in the policy at block 506. For example, the edge network device 306 illustrated in FIG. 3 may select the NAT method based on the data traffic matching a respective configuration of the one or more configurations in the SD-WAN data policy 304. The NAT method is chosen from a plurality of NAT methods in the policy corresponding to one or more WAN links 210, show in FIG. 2, associated with a WAN IP address or a NAT pool 1 318.

According to some examples, the method includes selecting an available DIA path that corresponds to the respective configuration and a specific WAN link managed by the one or more ISPs at block 508. For example, the edge network device 306 illustrated in FIG. 3 may select an available DIA path that corresponds to the respective configuration and a specific WAN link 1 322 or 324 managed by one or more ISPs.

According to some examples, the method includes selecting the WAN IP address that is consistent with the NAT method specified by the policy at block 510. For example, the edge network device 306 illustrated in FIG. 3 may select the WAN IP address that is consistent with the NAT method specified by the SD-WAN data policy 304. The WAN IP addresses are associated with one or more ISPs and are applied to the data traffic.

According to some examples, the method includes routing the data traffic along the available WAN link based on the one or more configurations and the WAN IP address applied during the NAT method in accordance with the policy at block 512. For example, the edge network device 306 illustrated in FIG. 3 may route the data traffic along the available WAN link based on the one or more configurations and the WAN IP address applied during the NAT method in accordance with the SD-WAN data policy 304.

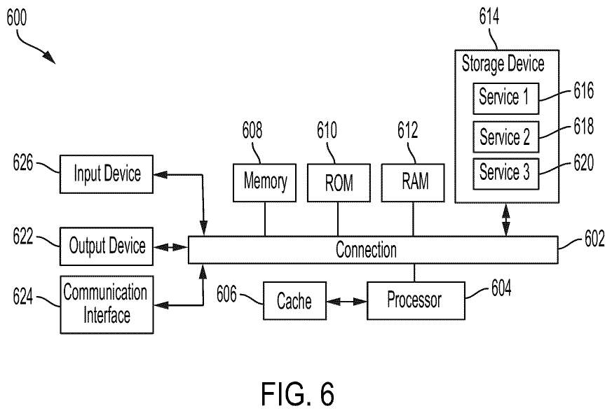

FIG. 6 shows an example of computing system 600, which can be for example any computing device making up a system network, or any component thereof in which the components of the system are in communication with each other using connection 602. Connection 602 can be a physical connection via a bus, or a direct connection into processor 604, such as in a chipset architecture. Connection 602 can also be a virtual connection, networked connection, or logical connection.

In some embodiments, computing system 600 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example computing system 600 includes at least one processing unit (central processing unit (CPU) or processor) and connection 602 that couples various system components including system memory 608, such as read-only memory (ROM 610) and random access memory (RAM 612) to processor 604. Computing system 600 can include a cache of memory 608, which can be high-speed, connected directly with, in close proximity to, or integrated as part of processor 604.

Processor 604 can include any general-purpose processor and a hardware service or software service, such as services 616, 618, and 620 stored in storage device 614, configured to control processor 604 as well as a special-purpose processor where software instructions are incorporated into the actual processor design. Processor 604 may essentially be a completely self-contained computing system, containing multiple cores or processors, a bus, memory controller, cache 606, etc. A multi-core processor may be symmetric or asymmetric.

To enable user interaction, computing system 600 includes an input device 626, which can represent any number of input mechanisms, such as a microphone for speech, a touch-sensitive screen for gesture or graphical input, keyboard, mouse, motion input, speech, etc. Computing system 600 can also include output device 622, which can be one or more of a number of output mechanisms known to those of skill in the art. In some instances, multimodal systems can enable a user to provide multiple types of input/output to communicate with computing system 600. Computing system 600 can include communication interface 624, which can generally govern and manage the user input and system output. There is no restriction on operating on any particular hardware arrangement, and therefore the basic features here may easily be substituted for improved hardware or firmware arrangements as they are developed.

Storage device 614 can be a non-volatile memory device and can be a hard disk or other types of computer-readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 614 can include software services, servers, services, etc., that when the code that defines such software is executed by the processor 604, it causes the system to perform a function. In some embodiments, a hardware service that performs a particular function can include the software component stored in a computer-readable medium in connection with the hardware components, such as processor 604, connection 602, output device 622, etc., to carry out the function.

For clarity of explanation, in some instances, the present technology may be presented as including individual functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in the memory of a client device and/or one or more servers of a content management system and performs one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data that cause or otherwise configure a general-purpose computer, special-purpose computer, or special-purpose processing device to perform a certain function or group of functions. Portions of computer resources used can be accessible over a network. The computer-executable instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smart phones, small form factor personal computers, personal digital assistants, and so on. Functionality described herein can also be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

Some aspects of the present technology include:

Clause 1. A method for managing traffic in a software-defined wide area network (SD-WAN) controller, comprising: receiving a policy at an edge network device in an SD-WAN from an SD-WAN controller, the policy specifying a network address translation (NAT) method for direct Internet access (DIA) action, and includes one or more configurations for selection of the NAT method; receiving, at the edge network device, data traffic, wherein the data traffic is matched with the one or more configurations in the policy to identify a NAT method that supports the data traffic received; selecting the NAT method based on the data traffic matching a respective configuration of the one or more configurations in the policy; selecting an available DIA path that corresponds to the respective configuration; selecting an IP address that is consistent with the NAT method specified by the policy to apply to the data traffic; and routing the data traffic along the available DIA path based on the one or more configurations and the IP address applied during the NAT method in accordance with the policy.

Clause 2. The method of clause 1, wherein the selection of the NAT method includes: receiving, at the edge network device, the data traffic associated with an application, wherein the data traffic is matched with an application type supported by the policy associated with the NAT method; selecting the NAT method based on the application type matching the respective configuration of the one or more configurations in the policy; and selecting the IP address that is consistent with the NAT method associated with the application type as specified by the policy.

Clause 3. The method of clause 1, wherein the NAT method is selected based on an indication in the policy and the available DIA path for an application type associated with an application.

Clause 4. The method of clause 1, wherein: the policy is configured by an administrator of the SD-WAN at a central management platform, the policy specifying the NAT method for the DIA action; and the policy is pushed from the central management platform to the SD-WAN controller to disseminate the policy to one or more edge network devices in the SD-WAN.

Clause 5. The method of clause 1, wherein each NAT method is associated with one or more WAN interfaces of an SD-WAN network topology.

Clause 6. The method of clause 1, wherein the policy includes criteria for matching one or more applications and comprises multiple NAT methods for an application type based on a DIA path preference and an availability of the DIA path preference.

Clause 7. The method of clause 1, further comprising: determining from the data traffic received from one or more edge network devices in the SD-WAN that the data traffic originated from an edge network device associated with specific source IP addresses; and assigning one or more IP addresses to the data traffic based on the edge network device the data traffic originated from.

Clause 8. The method of clause 1, further comprising: receiving one or more instructions from network resources in the SD-WAN, wherein the one or more instructions are utilized to apply one or more NAT methods in the policy to data traffic received from an application.

Clause 9. The method of clause 1, wherein the policy specifies multiple NAT methods for one or more corresponding DIA paths, the multiple NAT methods specifying a NAT pool or a WAN IP address to assign to the data traffic.

Clause 10. A network device comprising: one or more memories having computer-readable instructions stored therein; and one or more processors configured to execute the computer-readable instructions to: receiving a policy at an edge network device in an SD-WAN from an SD-WAN controller, the policy specifying a network address translation (NAT) method for direct Internet access (DIA) action, and includes one or more configurations for selection of the NAT method; receiving, at the edge network device, data traffic, wherein the data traffic is matched with the one or more configurations in the policy to identify a NAT method that supports the data traffic received; selecting the NAT method based on the data traffic matching a respective configuration of the one or more configurations in the policy; selecting an available DIA path that corresponds to the respective configuration; selecting an IP address that is consistent with the NAT method specified by the policy to apply to the data traffic; and routing the data traffic along the available DIA path based on the one or more configurations and the IP address applied during the NAT method in accordance with the policy.

Clause 11. The network device of clause 10, wherein the selection of the NAT method includes: receiving, at the edge network device, the data traffic associated with an application, wherein the data traffic is matched with an application type supported by the policy associated with the NAT method; selecting the NAT method based on the application type matching the respective configuration of the one or more configurations in the policy; and selecting the IP address that is consistent with the NAT method associated with the application type as specified by the policy.

Clause 12. The network device of clause 10, wherein the NAT method is selected based on an indication in the policy and the available DIA path for an application type associated with an application.

Clause 13. The network device of clause 10, wherein: the policy is configured by an administrator of the SD-WAN at a central management platform, the policy specifying the NAT method for the DIA action; and the policy is pushed from the central management platform to the SD-WAN controller to disseminate the policy to one or more edge network devices in the SD-WAN.

Clause 14. The network device of clause 10, wherein each NAT method is associated with one or more WAN interfaces of an SD-WAN network topology.

Clause 15. The network device of clause 10, wherein the policy includes criteria for matching one or more applications and comprises multiple NAT methods for an application type based on a DIA path preference and an availability of the DIA path preference.

Clause 16. The network device of clause 10, further comprising: determining from the data traffic received from one or more edge network devices in the SD-WAN that the data traffic originated from an edge network device associated with specific source IP addresses; and assigning one or more IP addresses to the data traffic based on the edge network device the data traffic originated from.

Clause 17. A non-transitory computer-readable storage medium comprising computer-readable instructions, which when executed by one or more processors of a network appliance, cause the network appliance to: receiving a policy at an edge network device in an SD-WAN from an SD-WAN controller, the policy specifying a network address translation (NAT) method for direct Internet access (DIA) action, and includes one or more configurations for selection of the NAT method; receiving, at the edge network device, data traffic, wherein the data traffic is matched with the one or more configurations in the policy to identify a NAT method that supports the data traffic received; selecting the NAT method based on the data traffic matching a respective configuration of the one or more configurations in the policy; selecting an available DIA path that corresponds to the respective configuration; selecting an IP address that is consistent with the NAT method specified by the policy to apply to the data traffic; and routing the data traffic along the available DIA path based on the one or more configurations and the IP address applied during the NAT method in accordance with the policy.

Clause 18. The non-transitory computer-readable storage medium of clause 17, wherein the selection of the NAT method includes: receiving, at the edge network device, the data traffic associated with an application, wherein the data traffic is matched with an application type supported by the policy associated with the NAT method; selecting the NAT method based on the application type matching the respective configuration of the one or more configurations in the policy; and selecting the IP address that is consistent with the NAT method associated with the application type as specified by the policy.

Clause 19. The non-transitory computer-readable storage medium of clause 17, wherein the NAT method is selected based on an indication in the policy and the available DIA path for an application type associated with an application.

Clause 20. The non-transitory computer-readable storage medium of clause 17, wherein: the policy is configured by an administrator of the SD-WAN at a central management platform, the policy specifying the NAT method for the DIA action; and the policy is pushed from the central management platform to the SD-WAN controller to disseminate the policy to one or more edge network devices in the SD-WAN.

Clause 21. The non-transitory computer-readable storage medium of clause 17, wherein each NAT method is associated with one or more WAN interfaces of an SD-WAN network topology.

Clause 22. The non-transitory computer-readable storage medium of clause 17, wherein the policy includes criteria for matching one or more applications and comprises multiple NAT methods for an application type based on a DIA path preference and an availability of the DIA path preference.

Clause 23: A method for managing traffic in a software-defined wide area network (SD-WAN) controller, includes receiving a policy at an edge network device in an SD-WAN from an SD-WAN controller, the policy specifying a network address translation method (NAT method) for direct Internet access (DIA) action, and includes one or more configurations for selection of the NAT method per WAN link managed by one or more Internet Service Providers), receiving, at the edge network device, data traffic, where the data traffic is matched with the one or more configurations in the policy to identify the NAT method that supports the data traffic received, selecting the NAT method based on the data traffic matching a respective configuration of the one or more configurations in the policy, where the NAT method is selected from a plurality of NAT methods in the policy corresponding to one or more WAN links associated with a WAN IP address or a NAT pool, selecting an available DIA path that corresponds to the respective configuration and a specific WAN link managed by the one or more ISPs, selecting the WAN IP address that is consistent with the NAT method specified by the policy that is associated with the one or more ISPs to apply to the data traffic, and routing the data traffic along the available DIA path based on the one or more configurations and the WAN IP address applied during the NAT method in accordance with the policy.

What is claimed is:

1. A method for managing traffic in a software-defined wide area network (SD-WAN) controller, comprising:
receiving a policy at an edge network device in an SD-WAN from an SD-WAN controller, the policy specifying a network address translation method (NAT method) for direct Internet access action (DIA action), and includes one or more configurations for selection of the NAT method;
receiving, at the edge network device, data traffic, wherein the data traffic is matched with the one or more configurations in the policy to identify the NAT method that supports the data traffic received;
selecting the NAT method based on the data traffic matching a respective configuration of the one or more configurations in the policy;
selecting an available DIA path that corresponds to the respective configuration;
selecting an IP address that is consistent with the NAT method specified by the policy to apply to the data traffic; and
routing the data traffic along the available DIA path based on the one or more configurations and the IP address applied during the NAT method in accordance with the policy.

2. The method of claim 1, wherein the selection of the NAT method includes:
receiving, at the edge network device, the data traffic associated with an application, wherein the data traffic is matched with an application type supported by the policy associated with the NAT method;
selecting the NAT method based on the application type matching the respective configuration of the one or more configurations in the policy; and
selecting the IP address that is consistent with the NAT method associated with the application type as specified by the policy.

3. The method of claim 1, wherein the NAT method is selected based on an indication in the policy and the available DIA path for an application type associated with an application.

4. The method of claim 1, wherein:
the policy is configured by an administrator of the SD-WAN at a central management platform, the policy specifying the NAT method for the DIA action; and
the policy is pushed from the central management platform to the SD-WAN controller to disseminate the policy to one or more edge network devices in the SD-WAN.

5. The method of claim 1, wherein each NAT method is associated with one or more WAN interfaces of an SD-WAN network topology.

6. The method of claim 1, wherein the policy includes criteria for matching one or more applications and comprises multiple NAT methods for an application type based on a DIA path preference and an availability of the DIA path preference.

7. The method of claim 1, further comprising:
determining from the data traffic received from one or more edge network devices in the SD-WAN that the data traffic originated from a first edge network device associated with specific source IP addresses; and
assigning one or more IP addresses to the data traffic based on the first edge network device the data traffic originated from.

8. A network device comprising:
one or more memories having computer-readable instructions stored therein; and
one or more processors configured to execute the computer-readable instructions to:
receiving a policy at an edge network device in an SD-WAN from an SD-WAN controller, the policy specifying a network address translation method (NAT method) for direct Internet access action (DIA action), and includes one or more configurations for selection of the NAT method;
receiving, at the edge network device, data traffic, wherein the data traffic is matched with the one or more configurations in the policy to identify a NAT method that supports the data traffic received;
selecting the NAT method based on the data traffic matching a respective configuration of the one or more configurations in the policy;
selecting an available DIA path that corresponds to the respective configuration;
selecting an IP address that is consistent with the NAT method specified by the policy to apply to the data traffic; and
routing the data traffic along the available DIA path based on the one or more configurations and the IP address applied during the NAT method in accordance with the policy.

9. The network device of claim 8, wherein the selection of the NAT method includes:
receiving, at the edge network device, the data traffic associated with an application, wherein the data traffic is matched with an application type supported by the policy associated with the NAT method;
selecting the NAT method based on the application type matching the respective configuration of the one or more configurations in the policy; and
selecting the IP address that is consistent with the NAT method associated with the application type as specified by the policy.

10. The network device of claim 8, wherein the NAT method is selected based on an indication in the policy and the available DIA path for an application type associated with an application.

11. The network device of claim 8, wherein:
the policy is configured by an administrator of the SD-WAN at a central management platform, the policy specifying the NAT method for the DIA action; and
the policy is pushed from the central management platform to the SD-WAN controller to disseminate the policy to one or more edge network devices in the SD-WAN.

12. The network device of claim 8, wherein each NAT method is associated with one or more WAN interfaces of an SD-WAN network topology.

13. The network device of claim 8, wherein the policy includes criteria for matching one or more applications and comprises multiple NAT methods for an application type based on a DIA path preference and an availability of the DIA path preference.

14. The network device of claim 8, further comprising:
determining from the data traffic received from one or more edge network devices in the SD-WAN that the data traffic originated from a first edge network device associated with specific source IP addresses; and
assigning one or more IP addresses to the data traffic based on the first edge network device the data traffic originated from.

15. A non-transitory computer-readable storage medium comprising computer-readable instructions, which when executed by one or more processors of a network appliance, cause the network appliance to:
receiving a policy at an edge network device in an SD-WAN from an SD-WAN controller, the policy specifying a network address translation method (NAT method) for direct Internet access action (DIA action), and includes one or more configurations for selection of the NAT method;
receiving, at the edge network device, data traffic, wherein the data traffic is matched with the one or more configurations in the policy to identify the NAT method that supports the data traffic received;
selecting the NAT method based on the data traffic matching a respective configuration of the one or more configurations in the policy;
selecting an available DIA path that corresponds to the respective configuration;
selecting an IP address that is consistent with the NAT method specified by the policy to apply to the data traffic; and
routing the data traffic along the available DIA path based on the one or more configurations and the IP address applied during the NAT method in accordance with the policy.

16. The non-transitory computer-readable storage medium of claim 15, wherein the selection of the NAT method includes:
receiving, at the edge network device, the data traffic associated with an application, wherein the data traffic is matched with an application type supported by the policy associated with the NAT method;
selecting the NAT method based on the application type matching the respective configuration of the one or more configurations in the policy; and
selecting the IP address that is consistent with the NAT method associated with the application type as specified by the policy.

17. The non-transitory computer-readable storage medium of claim 15, wherein the NAT method is selected based on an indication in the policy and the available DIA path for an application type associated with an application.

18. The non-transitory computer-readable storage medium of claim 15, wherein:
the policy is configured by an administrator of the SD-WAN at a central management platform, the policy specifying the NAT method for the DIA action; and
the policy is pushed from the central management platform to the SD-WAN controller to disseminate the policy to one or more edge network devices in the SD-WAN.

19. The non-transitory computer-readable storage medium of claim 15, wherein each NAT method is associated with one or more WAN interfaces of an SD-WAN network topology.

20. The non-transitory computer-readable storage medium of claim 15, wherein the policy includes criteria for matching one or more applications and comprises multiple NAT methods for an application type based on a DIA path preference and an availability of the DIA path preference.
